(19) United States
(12) Patent Application Publication
(10) Pub. No.: US 2021/0203199 A1
(43) Pub. Date: Jul. 1, 2021

(54) INTERIOR PERMANENT MAGNET MOTOR FOR SUPERCHARGERS

(71) Applicant: IHI Corporation, Tokyo (JP)

(72) Inventors: Kai IIJIMA, Tokyo (JP); Tatsumi INOMATA, Tokyo (JP); Yuji SASAKI, Tokyo (JP); Hikaru SUGIURA, Tokyo (JP); Kuniaki IIZUKA, Tokyo (JP); Tatsuya FUKUI, Tokyo (JP); Ryosuke YUMOTO, Tokyo (JP); Yoshihito KATSU, Tokyo (JP)

(21) Appl. No.: 17/183,490

(22) Filed: Feb. 24, 2021

Related U.S. Application Data
(63) Continuation of application No. PCT/JP2019/031955, filed on Aug. 14, 2019.

(30) Foreign Application Priority Data
Sep. 3, 2018 (JP) 2018-164253

(51) Int. Cl. H02K 1/27; H02K 1/28; H02K 21/14; F02B 39/10

(52) U.S. Cl. CPC H02K 1/276; F02B 39/10; H02K 21/14; H02K 1/28

(57) ABSTRACT

An IPM motor includes a rotation shaft, a rotor, and a stator. The rotor includes a rotor body, a magnet, and a resin filled between the magnet and the rotor body. The magnet includes a magnet main surface, a magnet back surface, and a magnet side surface. The rotor body includes a slot side surface facing the magnet side surface. The slot side surface includes a first flat surface portion and an inclined surface portion. The resin includes a first side surface resin portion filled between the magnet side surface and the first flat surface portion and a second side surface resin portion filled between the magnet side surface and the inclined surface portion.

### CROSS-REFERENCE TO RELATED APPLICATION

This application is a continuation application of PCT Application No. PCT/JP2019/031955, filed Aug. 14, 2019, the entire contents of which are incorporated herein by reference.

### BACKGROUND

Patent Literatures 1 to 6 below disclose a so-called IPM motor (Interior Permanent magnet motor; embedded permanent magnet type motor). Specifically, Patent Literatures 1 to 6 disclose various configurations in which a magnet is disposed in a rotor.

In the configuration disclosed in Japanese Unexamined Patent Publication No. H5-83892 (Patent Literature 1), a field permanent magnet is inserted into a slot of a yoke. Further, in the configuration disclosed in Patent Literature 1, a polyester resin is filled between the permanent magnet and the yoke. Japanese Unexamined Patent Publication No. 2006-238584 (Patent Literature 2) discloses that a force in which a magnet embedded in a rotor main body presses the rotor main body is desirably uniform. Further, Patent Literature 2 discloses a method of manufacturing a rotor. In this manufacturing method, a filler is uniformly filled between a magnet and a wall surface of a hole portion in which the magnet is embedded. Japanese Unexamined Patent Publication No. 2004-23976 (Patent Literature 3) discloses a rotor of a motor. In the rotor, an iron core, a permanent magnet, and a frame of the rotor are strongly integrated. Japanese Unexamined Patent Publication No. 2004-147451 (Patent Literature 4) discloses a rotor. The rotor includes a frame in which a plurality of magnets are annularly arranged on an outer periphery of a stator. In the configuration disclosed in Japanese Unexamined Patent Publication No. 2002-359942 (Patent Literature 5), a permanent magnet is disposed in an accommodating hole of a rotor main body. Further, in the configuration disclosed in Patent Literature 5, a resin and a coil spring are disposed in a slit formed between the magnet and the rotor main body. Japanese Unexamined Patent Publication No. 2002-136008 (Patent Literature 6) discloses a rotor. The rotor relieves stress concentration due to a centrifugal force generated at a corner portion of a rotor slot.

### SUMMARY

When the rotor in which the magnet is embedded rotates, the magnet is influenced by centrifugal force acting in a direction moving away from a rotation axis. The magnet to which the centrifugal force is applied is supported by the rotor. Thus, a load is applied to the rotor according to the centrifugal force. When an output of the motor increases, the centrifugal force also increases. As a result, the magnitude of the centrifugal force which can be borne by the rotor is determined by the mechanical strength of the rotor. That is, the upper limit of the motor output is determined by the mechanical strength of the rotor.

The present disclosure describes an interior permanent magnet motor for superchargers capable of improving a motor output.

An example of the present disclosure is an embedded permanent magnet type interior permanent magnet motor for superchargers. The interior permanent magnet motor for superchargers includes a rotation shaft; a rotor rotating together with the rotation shaft; and a stator including a wire disposed to surround the rotor. The rotor includes a rotor main body fixed to the rotation shaft, a magnet including a magnet main surface and a magnet back surface intersecting a rotation axis of the rotation shaft and a magnet side surface connecting the magnet main surface and the magnet back surface to each other and attached to the rotor main body, and a resin filled between the magnet and the rotor main body. The rotor main body includes a main body side surface facing the magnet side surface. The main body side surface includes a first main body side surface portion of which a distance from the magnet side surface is constant and a second main body side surface portion having a portion of which a distance from the magnet side surface increases. The resin includes a first resin portion filled between the magnet side surface and the first main body side surface portion and a second resin portion filled between the magnet side surface and the second main body side surface portion.

According to the present disclosure, an interior permanent magnet motor for superchargers capable of improving a motor output is provided.

### BRIEF DESCRIPTION OF DRAWINGS

FIG. 1 is a cross-sectional view illustrating an electric supercharger to which an IPM motor is applied.

FIG. 2 is an exploded perspective view of a rotor.

FIG. 3 is an enlarged plan view illustrating a main part of the rotor.

FIG. 4 is an enlarged plan view of a slot side surface.

FIG. 5A is a perspective view illustrating a position of a slot back surface and FIG. 5B is an enlarged perspective view illustrating a surface of the slot back surface.

### DETAILED DESCRIPTION

Hereinafter, an example of an interior permanent magnet motor for superchargers of the present disclosure will be described in detail with reference to the accompanying drawings. In the description of the drawings, the same components will be denoted by the same reference numerals and redundant description will be omitted.

An example of the present disclosure is an embedded permanent magnet type interior permanent magnet motor for superchargers. The interior permanent magnet motor for superchargers includes a rotation shaft; a rotor rotating together with the rotation shaft; and a stator including a wire disposed to surround the rotor. The rotor includes a rotor main body fixed to the rotation shaft, a magnet including a magnet main surface and a magnet back surface intersecting a rotation axis of the rotation shaft and a magnet side surface connecting the magnet main surface and the magnet back surface to each other and attached to the rotor main body, and a resin filled between the magnet and the rotor main body. The rotor main body includes a main body side surface facing the magnet side surface. The main body side surface includes a first main body side surface portion of which a distance from the magnet side surface is constant and a second main body side surface portion having a portion of which a distance from the magnet side surface increases. The resin includes a first resin portion filled between the magnet side surface and the first main body side surface portion and a second resin portion filled between the magnet side surface and the second main body side surface portion.

When a load caused by a centrifugal force is applied to the rotor main body, a portion in which stress increases due to bending occurs in a corner portion between the main body back surface and the main body side surface. At this time, a centrifugal load caused by the magnet is applied to a position on the inside of the corner portion. As a result, it is possible to reduce the stress generated at the corner portion between the main body back surface and the main body side surface. Here, the magnet side surface of the motor is fixed to the first main body side surface through the first resin portion. Further, the magnet side surface of the motor is fixed to the second main body side surface through the second resin portion. According to this configuration, a path (load path) for transmitting the load borne by the corner portion to the main body side surface is formed. Thus, the load borne by the corner portion between the main body back surface and the main body side surface is reduced. As a result, the limit value of the centrifugal force borne by the rotor main body can be increased. Thus, the limit value of the motor output can be also increased.

In one example, the magnet back surface may be farther from the rotation axis than the magnet main surface. The rotor main body may include a main body main surface facing the magnet main surface and a main body back surface facing the magnet back surface. The first main body side surface portion may be continuous to the main body main surface. The second main body side surface portion may be continuous to the main body back surface. According to this configuration, the load can be more suitably transmitted to the main body side surface. Thus, the limit value of the centrifugal force borne by the rotor main body can be further increased. As a result, the limit value of the motor output can be also further increased.

In one example, the resin may include a third resin portion filled between the magnet back surface and the main body back surface. According to this configuration, the magnet back surface does not directly contact the main body back surface. As a result, it is possible to suppress a load from being intensively applied to the magnet back surface due to the unevenness of the main body back surface. Thus, the limit value of the centrifugal force is further increased. As a result, the limit value of the motor output can be also further increased.

In one example, the rotor main body may include a curved surface portion which connects the main body back surface to the second main body side surface portion. According to this configuration, the curved surface portion is provided at the corner portion between the main body back surface and the second main body side surface portion where a portion in which stress increases is likely to occur. According to the curved surface portion, the degree of stress concentration is reduced. Thus, the limit value of the motor output can be further increased.

In one example, the magnet main surface may be in contact with the main body main surface. According to this configuration, the magnet can be attached to the rotor main body while being magnetized.

In one example, in the normal direction of the magnet side surface, the length from the first main body side surface portion to the outer peripheral surface of the rotor main body may be longer than the length from the second main body side surface portion to the outer peripheral surface of the rotor main body. According to this configuration, the load which can be borne by the first main body side surface portion increases. Thus, the limit value of the centrifugal force is further increased. As a result, the limit value of the motor output can be further increased.

In one example, the magnets may be disposed at equal intervals around the rotation axis. Also with this configuration, the limit value of the motor output can be suitably increased.

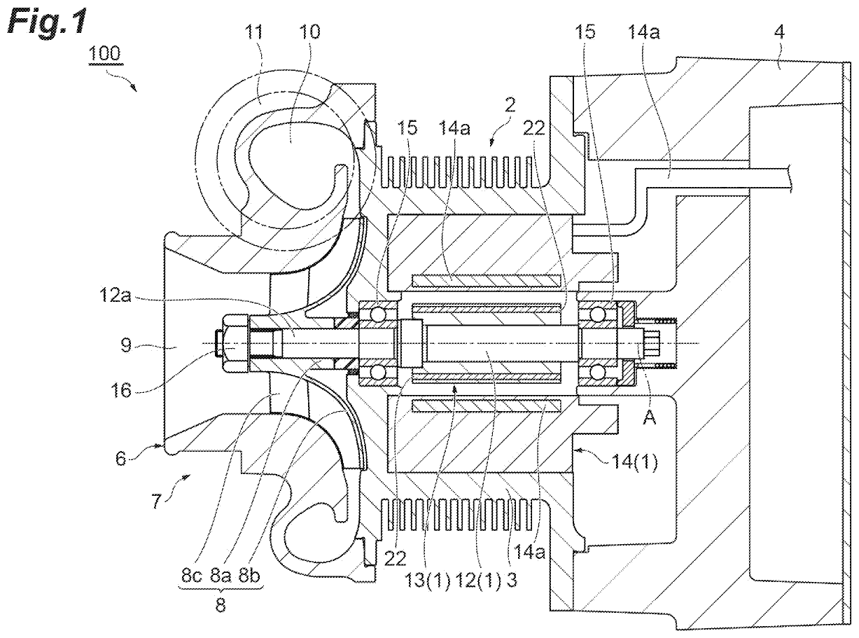

As illustrated in FIG. 1, an interior permanent magnet motor for superchargers (hereinafter, “IPM motor 1”) of the present disclosure is applied to an electric supercharger 100. The IPM motor 1 is not employed in a so-called turbocharger in superchargers. The IPM motor 1 is applied to a supercharger. The electric supercharger 100 is applied to, for example, internal combustion engines of vehicles and ships. The electric supercharger 100 includes a compressor 7. The electric supercharger 100 rotates a compressor impeller 8 by the interaction of a rotor 13 and a stator 14. As a result, the electric supercharger 100 generates compressed air by compressing a fluid such as air.

The electric supercharger 100 includes a rotation shaft 12 and a compressor impeller 8. The rotation shaft 12 is rotatably supported inside a housing 2. The rotation shaft 12 is provided inside the housing 2. Both ends of the rotation shaft 12 are supported by two bearings 15. The bearing 15 is press-inserted into the rotation shaft 12. The bearing 15 rotatably supports the rotation shaft 12 with respect to the housing 2. The bearing 15 is provided at each of the vicinity of a front end portion 12a of the rotation shaft 12 and the vicinity of a base end portion thereof. With this configuration, the rotation shaft 12 is supported by the bearing 15 at both sides. The bearing 15 is, for example, a grease-lubricated radial ball bearing. The bearing 15 may be a deep groove ball bearing. Further, the bearing 15 may be an angular ball bearing. The rotation shaft 12 is rotatable about a linear rotation axis A. The compressor impeller 8 is attached to the front end portion 12a of the rotation shaft 12.

The housing 2 includes a motor housing 3 and a base housing 4. The motor housing 3 accommodates the rotor 13 and the stator 14. The base housing 4 closes an opening on the side of the other end of the motor housing 3 (the right side of the drawing). The compressor housing 6 includes a suction port 9, a scroll portion 10, and a discharge port 11.

The rotor 13 is fixed to the axial center portion of the rotation shaft 12. The rotor 13 includes one or more magnets 22. The stator 14 is fixed to the inner surface of the motor housing 3 to surround the rotor 13. The stator 14 includes a wound wire portion 14a (wire).

An AC current flows to the stator 14 through the wire portion 14a. As a result, an interaction between the rotor 13 and the stator 14 occurs. Due to the interaction, the rotation shaft 12 and the compressor impeller 8 rotate together. When the compressor impeller 8 rotates, the compressor impeller 8 sucks external air through the suction port 9. The sucked air is compressed through the scroll portion 10. Then, the compressed air is discharged from the discharge port 11. The compressed air discharged from the discharge port 11 is supplied to an internal combustion engine.

The compressor impeller 8 includes a boss portion 8a, a hub 8b, and a vane 8c. The cylindrical boss portion 8a is disposed around the rotation axis A of the rotation shaft 12. The rotation shaft 12 penetrates the boss portion 8a. The hub 8b is connected to the boss portion 8a. The hub 8b extends in the radial direction of the rotation shaft 12 (the rotation axis A). The vane 8c protrudes from the boss portion 8a and the hub 8b toward the radial direction and the side of one end (the left side of the drawing) in the direction of the rotation axis A.

Hereinafter, the IPM motor 1 of the present disclosure will be described in detail. The IPM motor 1 (Interior Permanent magnet motor: IPM motor) is a rotating magnetic field type synchronous motor. The IPM motor 1 includes the rotation shaft 12, the rotor 13, and the stator 14 above-described.

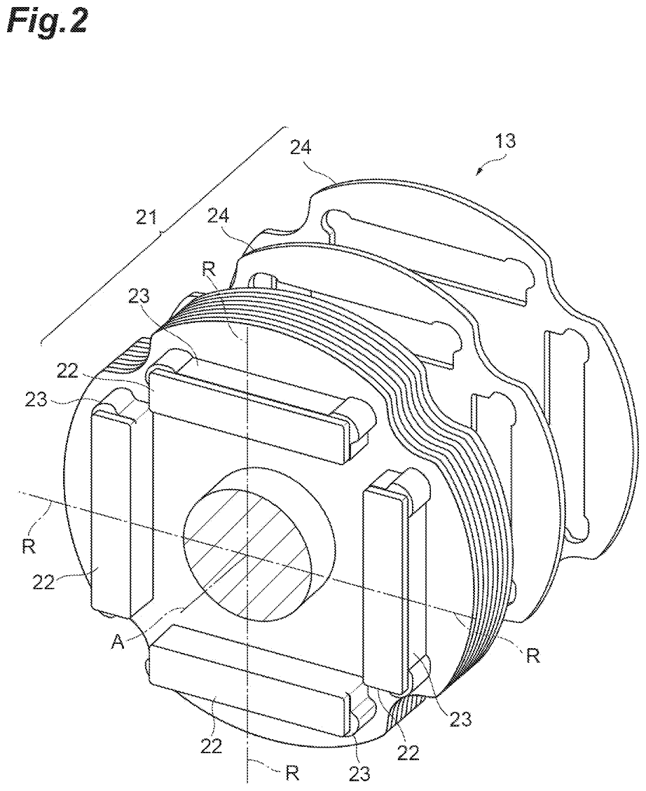

FIG. 2 is an exploded perspective view of the rotor 13. As illustrated in FIG. 2, the rotor 13 includes a rotor body 21 (rotor main body), four magnets 22 (magnets), and four resins 23. That is, the IPM motor 1 has four poles. The magnet 22 is fixed to the rotor body 21 by the resin 23. Thus, the resin 23 is an adhesive. As the resin 23, for example, an epoxy-based or phenol-based molding resin may be used. The magnet 22 has a plate shape extending in the direction of the rotation axis A. In the magnet 22, the length along the radial axis R is shorter than the length along the rotation axis A. The length of the magnet 22 along the radial axis R is the thickness of the magnet 22. The radial axis R means an axis which is orthogonal to the rotation axis A. That is, the radial axis R matches the diameter (or radius).

The rotor body 21 has a columnar shape extending in the direction of the rotation axis A. The rotor body 21 is formed by stacking a plurality of cores 24 in the thickness direction. The core 24 is made of, for example, an electromagnetic steel plate.

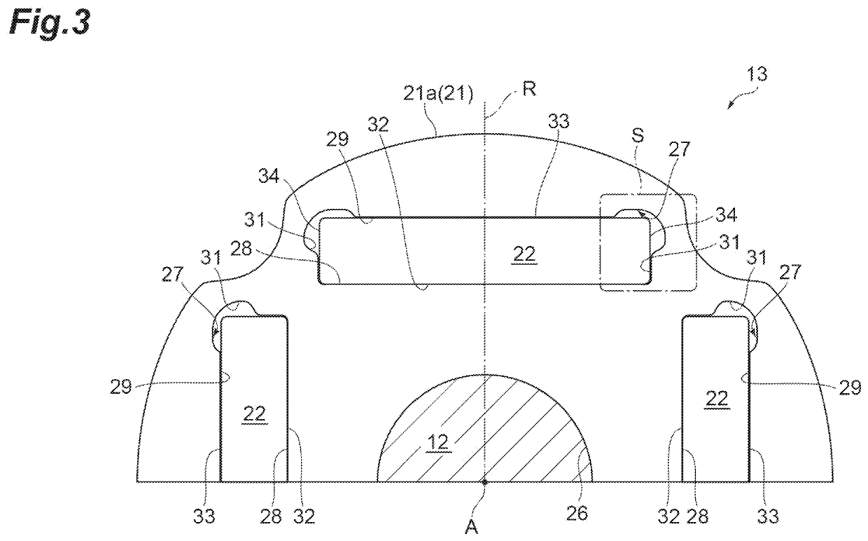

FIG. 3 is a front view of the rotor 13. As illustrated in FIG. 3, the rotor body 21 includes one rotation shaft hole 26 and four slots 27. The rotation shaft 12 is fixed to the rotation shaft hole 26. The slots 27 are provided at equal intervals (90°) around the rotation axis A. For example, it can be said that the slots 27 are disposed in a square shape to surround the rotation shaft 12. The magnet 22 is embedded in the slot 27 which is a through-hole. When the rotor body 21 is viewed from above in the direction of the rotation axis A, the slot 27 has a rectangular shape. It can be said that the shape of the slot 27 substantially corresponds to the outer shape of the magnet 22. However, the shape of the slot 27 does not precisely match the outer shape of the magnet 22. That is, a predetermined gap is formed between the wall surface of the slot 27 and the surface of the magnet 22. This gap is intentionally provided for the reason described later.

The slot 27 which is a rectangular shape hole is surrounded by four faces. The slot 27 is a space which is defined by a slot main surface 28 (a main body main surface), a slot back surface 29 (a main body back surface), and a pair of slot side surfaces 31 (main body side surfaces). The slot main surface 28 intersects the radial axis R. The normal of the slot main surface 28 matches the radial axis R. The normal of the slot main surface 28 faces an outer peripheral surface 21a of the rotor body 21. The slot back surface 29 intersects the radial axis R similarly to the slot main surface 28. The normal of the slot main surface 28 follows the radial axis R. The normal of the slot back surface 29 faces the rotation shaft 12. The slot back surface 29 is parallel to the slot main surface 28. The slot back surface 29 is a surface opposite to the slot main surface 28. The slot back surface 29 faces the slot main surface 28. The slot back surface 29 is not a simple flat surface. A more detailed shape of the slot back surface 29 will be described later.

The slot side surface 31 connects the slot main surface 28 to the slot back surface 29. The pair of slot side surfaces 31 faces each other. The slot side surface 31 is orthogonal to the slot main surface 28. The slot side surface 31 is also orthogonal to the slot back surface 29. The slot side surface 31 is not a simple flat surface similarly to the slot back surface 29. A more detailed shape of the slot side surface 31 will be described later.

The magnet 22 includes a magnet main surface 32 (a magnet main surface), a magnet back surface 33 (a magnet back surface), and a pair of magnet side surfaces 34 (magnet side surfaces). The magnet main surface 32 intersects the radial axis R. The normal of the magnet main surface 32 follows the radial axis R. The normal of the magnet main surface 32 faces the rotation shaft 12. Thus, the magnet main surface 32 faces the slot main surface 28.

The magnet back surface 33 intersects the radial axis R similarly to the magnet main surface 32. The normal of the magnet main surface 32 matches the radial axis R. The normal of the magnet back surface 33 faces the outer peripheral surface 21a of the rotor body 21. Thus, the magnet back surface 33 faces the slot back surface 29. The magnet back surface 33 is parallel to the magnet main surface 32. The magnet back surface 33 is a surface opposite to the magnet main surface 32. In other words, the distance from the rotation shaft 12 to the magnet back surface 33 is larger than the distance from the rotation shaft 12 to the magnet main surface 32.

The magnet side surface 34 connects the magnet main surface 32 to the magnet back surface 33. The magnet side surface 34 is orthogonal to the magnet main surface 32. The magnet side surface 34 is also orthogonal to the magnet back surface 33. The magnet side surface 34 faces the slot side surface 31. The length of the magnet side surface 34 along the radial axis R is the thickness of the magnet 22. The thickness of the magnet 22 is smaller than the length of the magnet 22 in the direction of the rotation axis A.

The magnet 22 is already magnetized while being inserted into the slot 27. In a state in which the magnet 22 is embedded in the slot 27, a magnetic pole is formed in a direction orthogonal to the rotation axis A. The magnet main surface 32 of the first magnet 22 has an N pole. The magnet back surface 33 of the first magnet 22 has an S pole. The magnet main surface 32 of the second magnet 22 adjacent to the first magnet 22 has an S pole. The magnet back surface 33 of the second magnet 22 has an N pole.

According to such an arrangement, a closed magnetic flux is formed by the adjacent magnets 22. As a result, the magnets 22 attract each other. The magnet main surface 32 is pressed against the slot main surface 28 by the attraction force. As a result, when the magnetized magnet 22 is inserted into the slot 27, the magnet main surface 32 directly contacts the slot main surface 28. As a result, a gap is not substantially formed between the magnet main surface 32 and the slot main surface 28. In the contact of the magnet main surface 32 and the slot main surface 28, a minute space formed by the surface roughness of the magnet main surface 32 and the slot main surface 28 is not regarded as a gap. A gap formed between the magnet 22 and the rotor body 21 is formed between the magnet back surface 33 and the slot back surface 29 and between the magnet side surface 34 and the slot side surface 31.

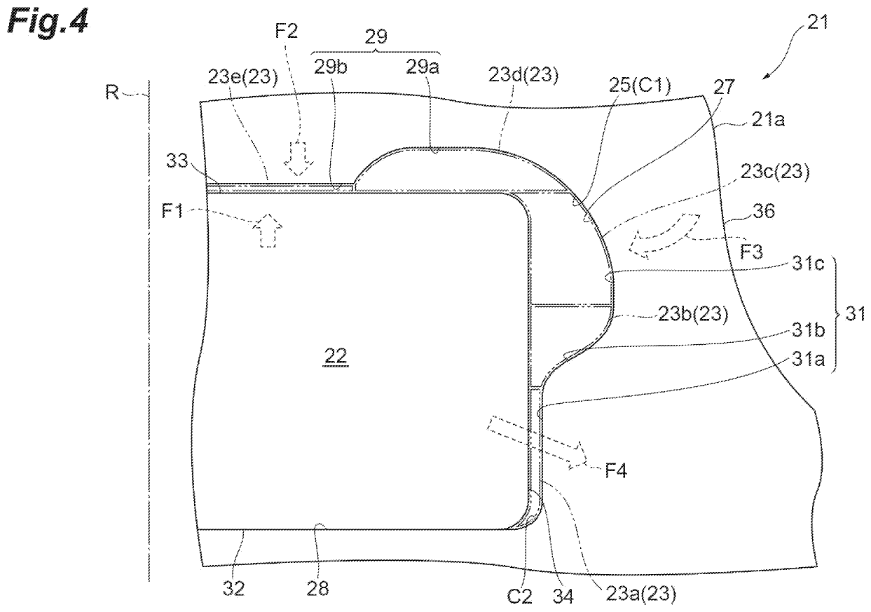

The shape of the slot 27 will be described in more detail with reference to FIG. 4. FIG. 4 is an enlarged view of an S part of FIG. 3.

The slot 27 includes four corner portions. Among four corner portions, two corner portions C1 form a shape for improving the output of the IPM motor 1. Specifically, a shape for improving an output is provided in the corner portion C1 between the slot back surface 29 and the slot side surface 31. Additionally, a so-called R corner (rounded corner) is provided in a corner portion C2 between the slot main surface 28 and the slot side surface 31.

As described above, the slot side surface 31 faces the magnet side surface 34. The resin 23 is filled between the slot side surface 31 and the magnet side surface 34. The magnet side surface 34 is a substantially flat surface. The slot side surface 31 includes a first flat surface portion 31a (a first main body side surface portion), an inclined surface portion 31b (a second main body side surface portion), and a first connection surface portion 31c. The first flat surface portion 31a is continuous to the slot main surface 28. The first connection surface portion 31c is continuous to the slot back surface 29. The inclined surface portion 31b is provided between the first flat surface portion 31a and the first connection surface portion 31c.

The first flat surface portion 31a having a flat surface shape is parallel to the radial axis R. The distance from one first flat surface portion 31a to the other first flat surface portion 31a is slightly longer than the length from one magnet side surface 34 to the other magnet side surface 34. According to this configuration, a gap can be provided between the magnet side surface 34 and the first flat surface portion 31a. The pair of first flat surface portions 31a may be used for a positioning operation when inserting the magnet 22 into the slot 27. The distance between the flat magnet side surface 34 and the flat first flat surface portion 31a is constant. As a result, the first side surface resin portion 23a (the first resin portion) filled between the magnet side surface 34 and the first flat surface portion 31a has a constant thickness. The length of the first flat surface portion 31a is, for example, about a half (½) of the thickness of the magnet 22.

The inclined surface portion 31b is inclined with respect to the radial axis R. Specifically, the distance from the magnet side surface 34 to the inclined surface portion 31b increases in a direction from the slot main surface 28 toward the slot back surface 29. The inclined surface portion 31b may be a flat surface or a curved surface. That is, the distance from the magnet side surface 34 to the inclined surface portion 31b may increase. As a result, the thickness of the second side surface resin portion 23b (the second resin portion) filled between the magnet side surface 34 and the inclined surface portion 31b changes in a direction from the slot main surface 28 toward the slot back surface 29. Specifically, the thickness of the second side surface resin portion 23b increases in a direction from the slot main surface 28 toward the slot back surface 29.

The first connection surface portion 31c may start from a position in which the distance from the magnet side surface 34 in the inclined surface portion 31b is the largest. The first connection surface portion 31c is inclined with respect to the radial axis R similarly to the inclined surface portion 31b. However, in the first connection surface portion 31c, the distance from the magnet side surface 34 to the first connection surface portion 31c decreases in a direction from the slot main surface 28 toward the slot back surface 29 contrary to the inclined surface portion 31b. As a result, the thickness of the third side surface resin portion 23c filled between the magnet side surface 34 and the first connection surface portion 31c changes in a direction from the slot main surface 28 toward the slot back surface 29. Specifically, the thickness of the third side surface resin portion 23c decreases in a direction from the slot main surface 28 toward the slot back surface 29. Additionally, the first connection surface portion 31c may be a flat surface instead of a curved surface.

The slot back surface 29 includes a second connection surface portion 29a and a second flat surface portion 29b. The second connection surface portion 29a is continuous to the slot side surface 31. Specifically, the second connection surface portion 29a is continuous to the first connection surface portion 31c. Thus, the corner portion C1 may be formed by the first connection surface portion 31c and the second connection surface portion 29a. The corner portion C1 may include the inclined surface portion 31b in addition to the first connection surface portion 31c and the second connection surface portion 29a. The second connection surface portion 29a is a curved surface. The second connection surface portion 29a connects the first connection surface portion 31c to the second flat surface portion 29b. As a result, the thickness of the first back surface resin portion 23d filled between the magnet back surface and the second connection surface portion 29a changes. Specifically, the thickness of the first back surface resin portion 23d decreases.

The second flat surface portion 29b having a flat surface shape is orthogonal to the radial axis R. The distance from the second flat surface portion 29b to the slot main surface 28 is slightly longer than the thickness of the magnet 22. The thickness of the magnet 22 is the length from the magnet main surface 32 to the magnet back surface 33. As a result, a gap can be provided between the magnet back surface 33 and the second flat surface portion 29b. The distance from the flat second flat surface portion 29b to the flat magnet back surface 33 is substantially constant. As a result, a second back surface resin portion 23e (a third resin portion) filled between the magnet back surface 33 and the second flat surface portion 29b has a constant thickness.

As described above, the resin 23 includes a first side surface resin portion 23a, a second side surface resin portion 23b, a third side surface resin portion 23c, a first back surface resin portion 23d, and a second back surface resin portion 23e. These resin portions are integrated with each other to form the resin 23. Then, the first side surface resin portion 23a, the second side surface resin portion 23b, the third side surface resin portion 23c, the first back surface resin portion 23d, and the second back surface resin portion 23e are adhered to the respective contact surfaces. For example, the first side surface resin portion 23a does not slide with respect to the magnet side surface 34. Similarly, the first side surface resin portion 23a does not slide with respect to the first flat surface portion 31a.

The action and effect obtained by the IPM motor 1 will be described. The IPM motor 1 improves the output of the motor (for example, the number of rotations) by three actions to be described below. Additionally, the effect obtained by the IPM motor 1 does not require all of the first, second, and third actions. The effect of the IPM motor 1 is achieved when at least the first action is performed. When the second action and the third action are performed after performing the first action, the output of the motor can be further improved.

### First Action

When the rotor 13 rotates, a centrifugal force F1 is applied to the magnet 22. The centrifugal force F1 presses the magnet 22 toward the slot back surface 29. Here, the rotor body 21 of the present disclosure causes a reaction force F2 against the centrifugal force F1. For example, assuming that the magnet 22 is pressed against the slot back surface 29, the reaction force F2 against the pressing is generated in a bridge 36. The bridge 36 is a region between the slot side surface 31 and the outer peripheral surface 21a of the rotor body 21. When a magnetic material is disposed in this region, a magnetic path is easily formed. Thus, a magnetic path is formed between the magnet back surface 33 and the magnet main surface 32. As a result, since the magnetic flux reaching the stator 14 decreases, the efficiency of the motor decreases. Here, a magnetic path is not easily formed when the area (or the width) of the bridge 36 is decreased. As a result, more magnetic flux reaches the stator 14. That is, the bridge 36 is a flux barrier. On the other hand, there is a tendency that the mechanical strength decreases when the area (or the width) of the bridge 36 decreases. Thus, the limit value of the force which can be borne is suppressed when the centrifugal force is borne by the bridge 36. As a result, the output (for example, the number of rotations) of the motor is not easily improved.

Here, the rotor 13 of the present disclosure has a configuration in which a force against the centrifugal force F1 is borne in a portion thicker than the bridge 36. Specifically, the rotor 13 has a configuration in which a force F4 against the centrifugal force F1 is borne in a region closer to the rotation axis A than the bridge 36. Specifically, a region closer to the rotation axis A than the bridge 36 is a region between the first flat surface portion 31a and the outer peripheral surface 21a.

Here, a case in which the centrifugal force F1 is applied to the magnet 22 is assumed. The magnet back surface 33 and the magnet side surface 34 of the magnet 22 are restrained by the resin 23. On the other hand, the magnet main surface 32 is only in contact with the slot main surface 28 due to the magnetic force between the magnets 22. Thus, the magnet main surface 32 is not restrained with respect to the slot main surface 28.

When the centrifugal force F1 is applied, the reaction force F2 is generated in the slot back surface 29. When the slot side surface 31 is assumed as a fixed end, a curved beam centered on the corner portion C1 of the slot 27 is assumed. As a result, the bending stress F3 occurs. Thus, a sharp stress peak occurs in the vicinity of a curved surface portion 25 in the slot 27.

As a result of the careful examination of the inventors, it is found that the bending stress F3 generated in the corner portion C1 between the slot back surface 29 and the slot side surface 31 can be reduced when the bending deformation is reduced. Here, in order to reduce the bending deformation, the magnet side surface 34 is fixed to the first flat surface portion 31a through the first side surface resin portion 23a and the magnet side surface 34 is fixed to the inclined surface portion 31b through the second side surface resin portion 23b. According to this configuration, a path that transmits a load to the slot side surface 31 is formed. In other words, a load path that transmits a load to the first flat surface portion 31a and the inclined surface portion 31b is formed. Specifically, a movement separating from the slot side surface 31 occurs in the magnet side surface 34 when the magnet 22 is deformed to be bent. A force F4 that disturbs the separation of the magnet side surface 34 is generated in the rotor body 21. Thus, a load that is borne by the corner portion C1 between the slot back surface 29 and the slot side surface 31 is reduced. The limit value of the centrifugal force F1 that is allowed by the rotor body 21 can be increased. As a result, the limit value of the motor output can be also increased. In other words, the limit value of the centrifugal force F1 which can be allowed by the rotor body 21 is increased due to the effect that the rotor body 21 of the IPM motor 1 does not apply the centrifugal load of the magnet 22 to the outer peripheral side of the rotor body 21 and the effect that the bending deformation is regulated by using the magnet 22 as a rigid member.

### Second Action

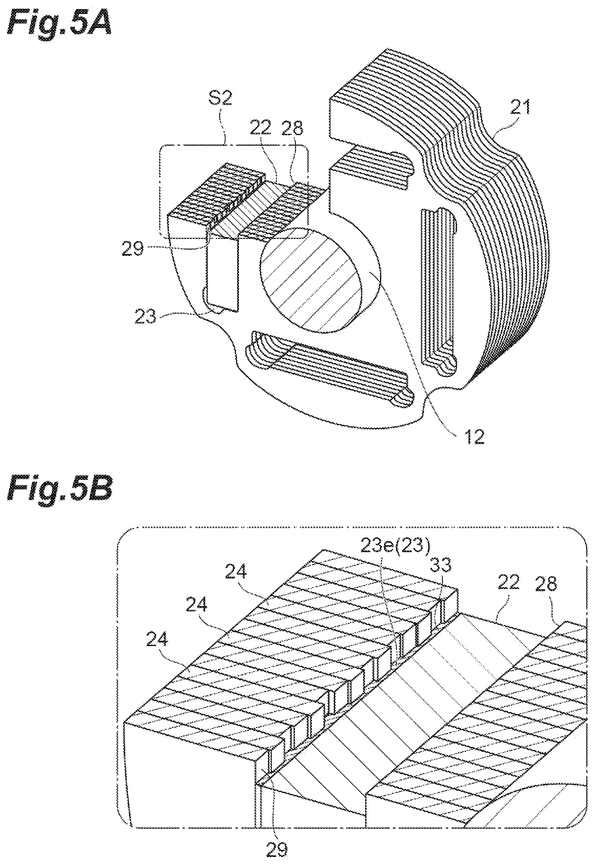

Incidentally, as illustrated in FIGS. 5A and 5B, a minute unevenness may exist in the slot back surface 29 in some cases when the slot back surface 29 is viewed in an enlarged state. The rotor body 21 is formed by staking the plurality of cores 24. Thus, there is a possibility that a minute unevenness may be formed in the slot back surface 29 due to the dimensional error and the assembly error of the core 24. It is assumed that a centrifugal force is applied to the magnet 22 so that the magnet 22 is directly pressed against the slot back surface 29. Therefore, the magnet back surface 33 has a contact position and a non-contact position with respect to the core 24. As a result, stress concentrates on a contact position of the core 24. Since stress is intensively applied to the magnet 22, there is a possibility that the output of the motor may be limited.

Here, the resin 23 includes the second back surface resin portion 23e filled between the magnet back surface 33 and the slot back surface 29. According to this configuration, the magnet back surface 33 does not directly contact the slot back surface 29. Specifically, the unevenness of the slot back surface 29 is absorbed by the third side surface resin portion 23e. As a result, when a centrifugal force is applied to the magnet 22, the magnet back surface 33 is uniformly pressed toward the third side surface resin portion 23e. Thus, it is possible to suppress a load from being intensively applied to the magnet back surface 33 due to the surface roughness of the second flat surface portion 29b in the slot back surface 29. Thus, since the limit value of the centrifugal force is further increased, the limit value of the motor output can be further increased.

### Third Action

In the description of the first action, it has been mentioned that the bending stress F3 can be generated at the corner portion C1 between the magnet back surface 33 and the magnet side surface 34. Here, the rotor body 21 of the IPM motor 1 includes the curved surface portion 25 (see FIG. 4) provided at the corner portion C1. The curved surface portion 25 includes the first connection surface portion 31c and the second connection surface portion 29a. According to this configuration, the curved surface portion 25 is provided at the corner portion C1 between the slot back surface 29 and the slot side surface 31 where a portion in which stress increases is likely to occur. According to the curved surface portion 25, the degree of stress concentration is reduced. Thus, the limit value of the motor output can be further increased.

As described above, the examples of the present disclosure have been described. The IPM motor 1 according to the present disclosure is not limited to the above-described examples. It is to be understood that not all aspects, advantages and features described herein may necessarily be achieved by, or included in, any one particular example. Indeed, having described and illustrated various examples herein, it should be apparent that other examples may be modified in arrangement and detail.

1. An interior permanent magnet motor for superchargers comprising:
a rotation shaft;
a rotor rotating together with the rotation shaft; and
a stator comprising a wire disposed to surround the rotor,
wherein the rotor comprises:
a rotor main body fixed to the rotation shaft;
a magnet which is attached to the rotor main body and comprising a magnet main surface and a magnet back surface which intersects a radial axis which intersects a rotation axis of the rotation shaft, and a magnet side surface connecting the magnet main surface to the magnet back surface; and
a resin filled between the magnet and the rotor main body,
wherein the rotor main body comprises a main body side surface which faces the magnet side surface,
wherein the main body side surface comprises:
a first main body side surface portion of which a distance from the magnet side surface is constant; and
a second main body side surface portion of which a distance from the magnet side surface increases, and
wherein the resin comprises:
a first resin portion which is filled between the magnet side surface and the first main body side surface portion; and
a second resin portion which is filled between the magnet side surface and the second main body side surface portion.

2. The interior permanent magnet motor for superchargers according to claim 1,
wherein the magnet back surface is located farther from the rotation axis than the magnet main surface,
wherein the rotor main body comprises:
a main body main surface facing the magnet main surface; and
a main body back surface facing the magnet back surface,
wherein the first main body side surface portion is continuous to the main body main surface, and
wherein the second main body side surface portion is continuous to the main body back surface.

3. The interior permanent magnet motor for superchargers according to claim 2,
wherein the resin comprises a third resin portion filled between the magnet back surface and the main body back surface.

4. The interior permanent magnet motor for superchargers according to claim 2,
wherein the second main body side surface portion comprises a curved surface portion connected to the main body back surface.

5. The interior permanent magnet motor for superchargers according to claim 2,
wherein the magnet main surface is in contact with the main body main surface.

6. The interior permanent magnet motor for superchargers according to claim 1,
wherein in a direction of a normal of the magnet side surface, a length from the first main body side surface portion to an outer peripheral surface of the rotor main body is longer than a length from the second main body side surface portion to the outer peripheral surface of the rotor main body.

7. The interior permanent magnet motor for superchargers according to claim 1,
wherein a plurality of the magnets are disposed at an equal interval around the rotation axis.

8. An interior permanent magnet motor for superchargers comprising:
a rotation shaft;
a stator, and
a rotor comprising:
a rotor main body which is fixed to the rotation shaft;
a magnet which is attached to the rotor main body in a slot of the rotor main body; and
a resin filled between the magnet and the rotor main body,
wherein the magnet comprises:
a magnet main surface which intersects a radial axis which intersects a rotation axis of the rotation shaft;
a magnet back surface which intersects the radial axis; and
a magnet side surface which connects the magnet main surface to the magnet back surface,
wherein the slot comprises:
a main body main surface which faces the magnet main surface;
a main body back surface which faces the magnet back surface; and
a main body side surface which faces the magnet side surface; and
wherein the main body side surface comprises:
a first main body side surface portion of which a distance from the magnet side surface is substantially constant; and
a second main body side surface portion of which a distance from the magnet side surface varies.

9. The interior permanent magnet motor for superchargers according to claim 8,
wherein the second main body side surface portion is inclined with respect to the radial axis and the distance from the magnet side surface to the second main body side surface portion increases in a direction from the main body main surface toward the main body back surface.

10. The interior permanent magnet motor for superchargers according to claim 8,
wherein the second main body side surface portion is a flat surface.

11. The interior permanent magnet motor for superchargers according to claim 8,
wherein the second main body side surface portion is a curved surface.

12. The interior permanent magnet motor for superchargers according to claim 8,
wherein the resin comprises;
a first resin portion which is filled between the magnet side surface and the first main body side surface portion; and
a second resin portion which is filled between the magnet side surface and the second main body side surface portion, and
wherein a thickness of the first resin portion is substantially constant and a thickness of the second resin portion varies.

13. The interior permanent magnet motor for superchargers according to claim 12,
wherein the thickness of the second resin portion increases in a direction from the main body main surface toward the main body back surface.

14. The interior permanent magnet motor for superchargers according to claim 8,
wherein the main body side surface further comprises a third main body side surface portion of which a distance from the magnet side surface varies,
wherein the first main body side surface portion is adjacent to the main body main surface and the second main body side surface portion,
wherein the second main body side surface portion is adjacent to the first main body side surface portion and the third main body side surface portion, and
wherein the third main body side surface portion is adjacent to the second main body side surface portion and the main body back surface.

15. The interior permanent magnet motor for superchargers according to claim 14,
wherein the third main body side surface portion is inclined with respect to the radial axis and the distance from the magnet side surface to the third main body side surface portion decreases in a direction from the main body main surface toward the main body back surface.

16. The interior permanent magnet motor for superchargers according to claim 14,
wherein the third main body side surface portion is a flat surface.

17. The interior permanent magnet motor for superchargers according to claim 14,
wherein the third main body side surface portion is a curved surface.

18. The interior permanent magnet motor for superchargers according to claim 14,
wherein the resin further comprises a third resin portion which is filled between the magnet side surface and the third main body side surface portion,
wherein a thickness of the third resin portion decreases in a direction from the main body main surface toward the main body back surface.

19. The interior permanent magnet motor for superchargers according to claim 8,
wherein the main body back surface comprises:
a first main body back surface portion of which a distance from the magnet back surface is substantially constant; and
a second main body back surface portion of which a distance from the magnet side surface varies.

20. An interior permanent magnet motor for superchargers comprising:
a rotation shaft;
a stator, and
a rotor comprising:
a rotor main body which is fixed to the rotation shaft;
a magnet which is attached to the rotor main body in a slot of the rotor main body; and
a resin filled between the magnet and the rotor main body,
wherein the magnet comprises:
a magnet main surface which intersects a radial axis which intersects a rotation axis of the rotation shaft;
a magnet back surface which intersects the radial axis; and
a magnet side surface which connects the magnet main surface to the magnet back surface,
wherein the slot comprises:
a main body main surface which faces the magnet main surface;
a main body back surface which faces the magnet back surface;
a main body side surface which faces the magnet side surface; and
a corner portion between the main body side surface and the main body back surface, wherein a distance from the magnet to a surface of the slot at the corner portion varies.
